(19) United States
(12) Patent Application Publication
(10) Pub. No.: US 2017/0091758 A1
(43) Pub. Date: Mar. 30, 2017

(54) MERCHANT TOKENIZATION MIGRATION INFRASTRUCTURE SYSTEM

(71) Applicant: BANK OF AMERICA CORPORATION, Charlotte, NC (US)

(72) Inventors: Andrew D. Kim, Glendale, AZ (US); Gregory Joseph Lloyd, Charlotte, NC (US); Lauren Marie Zavodny, Charlotte, NC (US); James Gregory Ronca, Decatur, GA (US); Stephen Philip Selfridge, Huntersville, NC (US)

(21) Appl. No.: 14/870,790

(22) Filed: Sep. 30, 2015

(51) Int. Cl. G06Q 20/36; G06Q 20/38; G06Q 20/40

(52) U.S. Cl. CPC G06Q 20/3674; G06Q 20/401; G06Q 20/3821

(57) ABSTRACT

Embodiments of the invention are directed to a system, method, or computer program product for payment vehicle agnostic payment tokenization. In this way, the invention provides a means for a user to use a token for a transaction at a merchant without the merchant making infrastructural changes. The token may be specifically coded for merchant recognition and identification that the merchant's infrastructure is not capable of processing the received token. Instead of declining the transaction, code is implemented into the token that the merchant recognizes and routes the token to the invention infrastructure for authorization. The infrastructure then correlates the token to the appropriate account and finalizing authorization and payment routing based on the correlation.

### BACKGROUND

True implementation and migration to a tokenization system requires the merchant to overhaul or implement changes to the merchant's infrastructure for tokenization implementation. In this way, potentially large infrastructure overhauls are required at the merchant in order to migrate the system to accepting tokens for user interactions.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatuses (e.g., a system, computer program product and/or other devices) and methods for a system for payment vehicle agnostic payment tokenization. In this way, the system provides a method for a user to use a token with their account that is passed to the merchant without the merchant making infrastructural changes. The user requests a token for use with an account. The token may be one-time use, generalized, authorized for use within a certain category of purchases, authorized for a certain amount, authorized for a specific time frame, or the like. The requested token is provided to the user based on the request and associated with the requested account. During a transaction, the token is passed to the merchant. The token may be included or stored on a plastic card, on a device, or on a digital wallet. The merchant may recognize the token and identify that the merchant's infrastructure is not capable of completing the transaction using the received token. Instead of declining the transaction, code is implemented into the token that the merchant recognizes and routes the token to the system for authorization. As such, the token in a digital wallet or the like may include a routable number that can flow through the payment processing networks just as an account number would. The system includes the infrastructure for correlation that token to the appropriate account. Subsequently, the system may use the account number identified within a financial institution for authorization and payment routing back to the merchant to complete the transaction. In this way, the account number may be completely secret from the merchant and the user during the transaction.

Embodiments of the invention relate to systems, methods, and computer program products for generating a token specific infrastructure, wherein the infrastructure includes routing and payment processing applications; receiving a request from a user device for a token to be communicated to and implemented in a payment vehicle; coding the token, based on the request, to be compatible with the infrastructure, wherein the token includes code for merchant routing instructions to the infrastructure and user qualifications for the token; sending the token to the user device via a secure communicable link and store the token on the payment vehicle; identifying the token being pushed from the payment vehicle to a merchant system as part of a transaction; retrieving, based on the identification of the token being pushed to the merchant system, the token; correlating the token to a stored account number associated with a payment account; applying the token to the infrastructure and processing a payment via the payment processing application for authorization of the transaction; and communicating approved payment authorization processing to the merchant and the user to allow completion of the transaction.

In some embodiments, the merchant routing instructions further comprises instructions to route the token to the infrastructure upon being pushed to the merchant system for a transaction, wherein the merchant routing instructions include instructions to route transaction information including a total payment due for the transaction.

In some embodiments, user qualifications for the token comprise limitations for using the token based on merchant, time frame, or amount of the transaction.

In some embodiments, the payment vehicle is the user device or a microchip associated with a card.

In some embodiments, identifying the token being pushed from the payment vehicle to a merchant system further comprises receiving coded data from the token that the token is being pushed to a merchant system.

In some embodiments, retrieving the token further comprises retrieving transaction information including the merchant address, products of the transaction, a price for each of the products of the transaction, and a total payment due for the transaction.

In some embodiments, the token specific infrastructure comprises components for generating tokens with program code for routing the tokens to the infrastructure and routing, after the transaction has been initiated, the token to an appropriate payment routing application based on an identification of the account number associated with the payment account.

In some embodiments the invention further comprising performing condition diagnostics on the user device prior to sending the user device the token, wherein performing condition diagnostics comprises determining a security confidence rating for integration of the token to the payment vehicle, wherein the security confidence rating confirms that no malware is present on the user device prior to sending the token.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a tokenization migration system environment, in accordance with one embodiment of the present invention;

FIG. 2 provides a tokenization process flow, in accordance with one embodiment of the present invention;

FIG. 3 provides a tokenization process flow, in accordance with one embodiment of the present invention;

FIG. 4 provides a tokenization process flow, in accordance with one embodiment of the present invention;

FIG. 5 provides a high level process flow illustrating the non-infrastructural changing tokenization migration system process, in accordance with one embodiment of the present invention;

FIG. 6 provides a process map illustrating coding and generating a token for transaction utilization, in accordance with one embodiment of the present invention;

FIG. 7 provides a process map illustrating utilizing a token to complete a transaction and posting of the transaction, in accordance with one embodiment of the present invention; and

FIG. 8 provides process map illustrating system integration, data flow, and data transformation of the tokenization migration system, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, as used herein the invention creates an infrastructure for routing payments and completing payment processing via token presentation at a merchant. The infrastructure may be referred to as a payment infrastructure, token infrastructure, and/or internal infrastructure, that is created for the recognition and processing of tokens to complete a transaction with a merchant that may not have the infrastructure capabilities to complete and process a transaction using a token.

Presenting a credit card on a digital wallet may provide a visual bank or credit card to the user. As referred to herein, the visual bank or credit card may refer to, but is not limited to, an electronic or digital transaction vehicle that can be used to transfer money, make a payment (for a service or a good), withdraw money, and similar or related transactions. Using an approved/authorized banking channel of communication, which may include making a phone call, accessing online banking, walking into a branch banking center, using an automatic teller machine, or the like, a user may indicate that an existing physical transaction card associated with one or more financial accounts of the user is misplaced, lost, or has been misappropriated. Once the user is authenticated via the authorized banking channel, a request may be submitted for the instant issuance of a credit card. In response to the request the system may issue the credit card directly to a mobile device of the user. In that way, the user may easily display and use the virtual credit card prior to receiving the physical card for conducting a transaction.

Building an alternate payments ecosystem utilizing tokenization requires a number of entities working together in order to deliver alternative, such as near field communication (NFC) or other technology based payment services to the end users. One of the issues is the interoperability between the players and to resolve this issue the role of trusted service manager (TSM) is proposed to establish a technical link between a user device and providers of services, so that these entities can work together. Tokenization can play a role in mediating such services.

Tokenization as a security strategy lies in the ability to replace a real card number with a token number and the subsequent limitations placed on the token number. If the token number can be used in an unlimited fashion or even in a broadly applicable manner, the token value gains as much value as the real credit card number. In these cases, the taken may be secured by a second dynamic token that is unique for each transaction and also associated to a specific payment card. Examples of dynamic, transaction-specific tokens include cryptograms used in the EMV specification, and DDM mobile payment transactions.

Merchants do not always have the intricate and detailed infrastructure necessary to receive a token and process that token as a payment device or payment account tier a transaction. As such, the invention provides a migration system for token processing for merchants.

Embodiments of the invention are directed to a system, method, or computer program product for a distributive network system with specialized data feeds associated with the distributive network, specific triggering events associated with the data feeds, and data transformation throughout the data feeds to allow for a merchant to have non-infrastructural changes, but still allow for tokenization migration and acceptance. Specifically, tokens are coded for token migration to the system and away from a merchant recognized as not compatible with the tokenization process. In this way, while the merchant system is not compatible, the token may identify this and translate to the system infrastructure for subsequent processing. The system may subsequently process the transaction using the payment and code a message to the merchant, in a merchant compatible format, for completing the transaction with the user using the tokenization method incompatible with merchant infrastructures.

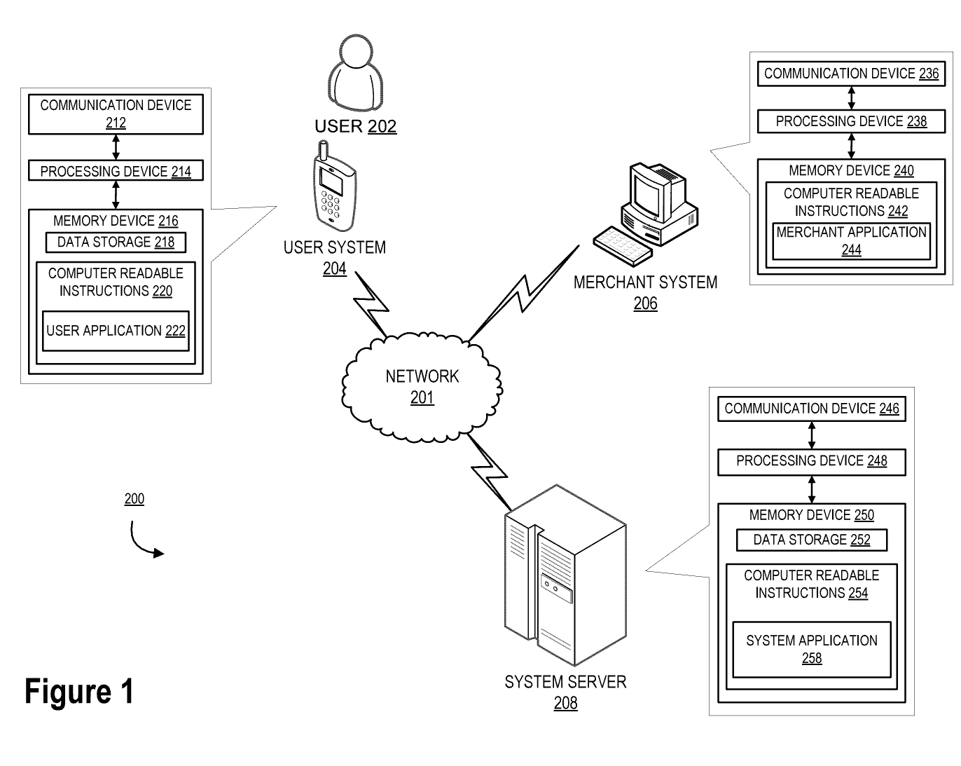

FIG. 1 illustrates a tokenization migration system environment 200, in accordance with one embodiment of the present invention. FIG. 1 provides the system environment 200 for which the distributive network system with specialized data feeds associated with the distributive network with specialized data feeds associated with the distributive network, specific triggering events associated with the data feeds, and data transformation throughout the data feeds to allow for a merchant to have non-infrastructural changes but still allow for tokenization migration and acceptance. FIG. 1 provides a unique system that includes specialized servers and system communicably linked across a distributive network of nodes required to generate uniquely coded tokens and allow those tokens to be stored on a user system 204, utilized in a transaction with a merchant system 206, and to be pulled and processed for payment via the system server 208 without infrastructural implementations to the merchant system 206. The system, with its communicably linked diffusible network may, in some embodiments, improve a computing device if utilized thereon by improving the ability for the computer device to read and route tokens for transactions that are incompatible with a computer device based on a lack of infrastructural changes to the device. Furthermore, in some embodiments, the system may be, as described below, run on a diffusion network of specialized nodes meant for a merchant tokenization migration system.

As illustrated in FIG. 1, the system server 208 is operatively coupled, via a network 201 to the user system 204, and to the merchant system 206. In this way, the system server 208 can send information to and receive information from the user system 204 and the merchant system 206 for merchant tokenization migration. Thus allowing an otherwise incompatible merchant system 206 (unable to accept standard tokenization transactions) to be able to receive and route payments for a transaction using tokenization means. FIG. 1 illustrates only one example of an embodiment of the system environment 200, and it will be appreciated that in other embodiments one or more of the systems, devices, or servers may be combined into a single system, device, or server, or be made up of multiple systems, devices, or servers.

The network 201 may be a system specific distributive network receiving and distributing specific network feeds and identifying specific network associated triggers. The network 201 may also be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the user 202 is an individual consumer that is transacting with a merchant. Furthermore, the user 202 is one or more individuals that may have an online banking presents and/or a digital wallet. The user 202 may make one or more transactions to purchase a product with a credit card via a digital wallet. In some embodiments, the purchase may be made by the user 202 using a user system 204.

FIG. 1 also illustrates a user system 204. The user system 204 generally comprises a communication device 212, a processing device 214, and a memory device 216. The user system 204 is a computing system that allows a user 202 to interact with the financial institution to generate a digital or mobile wallet, access online banking applications, and utilize a digital wallet for transaction completion at a merchant. The processing device 214 is operatively coupled to the communication device 212 and the memory device 216. The processing device 214 uses the communication device 212 to communicate with the network 201 and other devices on the network 201, such as, but not limited to the merchant system 206 and the system server 208. As such, the communication device 212 generally comprises a modem, server, or other device for communicating with other devices on the network 201.

The user system 204 comprises computer-readable instructions 220 and data storage 218 stored in the memory device 216, which in one embodiment includes the computer-readable instructions 220 of a user application 222. In this way, a user 202 may open a financial institution account, apply for credit cards, remotely communicate with the financial institution, authorize and complete a transaction, or complete a transaction using the user system 204 via a digital wallet. Furthermore, the user application 222 may receive, based on instructions, a token from the system server 208 and store on the memory device 216 of the user system 204. The user system 204 may be, for example, a desktop personal computer, a mobile system, such as a cellular phone, smart phone, personal data assistant (PDA), laptop, or the like.

As further illustrated in FIG. 1, the system server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the merchant system 206 and the user system 204. As such, the communication device 246 generally comprises a modem, server, or other device for communicating with other devices on the network 201.

As further illustrated in FIG. 1, the system server 208 comprises computer-readable instructions 254 stored in the memory device 250, which in one embodiment includes the computer-readable instructions 254 of a system application 258. In some embodiments, the memory device 250 includes data storage 252 for storing data related to the system environment, but not limited to data created and/or used by the system application 258.

In the embodiment illustrated in FIG. 1 and described throughout much of this specification, the system application 258 may create an infrastructure for processing tokens for a merchant, create tokens with code for infrastructure processing, provide the user system 204 with the token, receive or retrieve tokens from a merchant system 206, and process the transaction and/or payment routing.

In some embodiments, the system application 258 may create an infrastructure for processing tokens for a merchant. The infrastructure may be stored within the memory device 250 and be utilized to process, support, and route tokens for the completion of a transaction at a merchant. In this way, the infrastructure may be created by the system application 258 to read and route codes associated with tokens for payment transaction completion.

In some embodiments, the system application 258 may create tokens with code for infrastructure processing. The token may include code therein that includes a virtual image of the card, card number, CVV number, expiration data, and other disclosures of the card required to utilize the card for digital wallet transactions. In other embodiments, the token may include code that contains a generic token number that is associated internally at the infrastructure to a user account. In this way, a token, if misappropriated, may not be utilized. Furthermore, the system application 258 may further include code for routing the token, when used at a merchant, to the infrastructure for processing. In some embodiments, the code may allow the token to automatically be directed to the system application 258 upon use at a merchant. In yet other embodiments, the code may be universally read by a merchant system 206 to route the token to the system application 258.

In some embodiments, the system application 258 may provide the user system 204 with the token. As such, the token may be stored in the memory 216 of the user system 204 and subsequently decrypted to be used by the user system 204 as a payment means via a digital wallet. The token may also be stored and decrypted by the system application 258 for reconciliation and processing of the transaction at the financial institution post digital wallet transaction.

In some embodiments, the system application 258 may receive or retrieve tokens from a merchant system 206. In this way, the user 202 may desire to complete a transaction between the user 202 and merchant using a digital or mobile means. As such, the user 202 may present the token from the user device 204 to the merchant as payment for the transaction. Upon receiving the token, the merchant system 206 may recognize that it is incapable with respect to infrastructure, of processing the token for payment. In typical instances, the merchant may simply decline the token as payment and request a different payment means. However, with the token created and provided to the user 202 by the system application 258, the system server 208 may comprise the infrastructure to process and finalize payment of the transaction. In this way, the merchant system 206 may be capable of reading routing code associated with the token and route the token, based on the code, to the system server 208. In other embodiments, the system application 258 may have provided code to the token that may automatically, upon merchant system 206 receiving the token, be routed to the system application 258. In this way, the token may identify when it has been received at a merchant system 206 and at that point the token may instigate routing of itself to the system application 258 for processing.

In some embodiments, the system application 258 may process the transaction and/or payment routing. Once the system application 258 has received the token used by the user 202 for the transaction, the system application 258 may process the transaction and payment routing. In this way, the system application 258 may identify the payment account associated with the token, utilize that account number to instigate payment transaction and routing from that account. The system application 258 may then instigate transaction approval using the account associated with the token. In some embodiments, this may require the system application 258 to route the account through the necessary payment channels for approval. In other embodiments, the system application 258 may conduct the approval process.

Finally, after the system application 258 has authorized and received approval of payment transaction processing, the system application 258 may communicate the transaction approval to the merchant system 206 and user 202 so that the transaction may be finalized and a receipt may be provided.

As illustrated in FIG. 1, the merchant system 206 is connected to the system server 208 and is associated with a merchant selling products or services. In this way, while only one merchant system 206 is illustrated in FIG. 1, it is understood that multiple merchant systems may make up the system environment 200. The merchant system 206 generally comprises a communication device 236, a processing device 238, and a memory device 240. The merchant system 206 comprises computer-readable instructions 242 stored in the memory device 240, which in one embodiment includes the computer-readable instructions 242 of a merchant application 244.

In the embodiment illustrated in FIG. 1, the merchant application 244 provides products and services to a user 202 and is part of one or more user transactions. In some embodiments, the merchant application 244 may be part of a network associated with the merchant that provides products and services to a user 202 via online or mobile means. Furthermore, the merchant application 244 may be associate with a brink-and-mortar merchant location. As such, the merchant application 244 may be a part of one or more user transactions when the user 202 transacts with the merchant.

Furthermore the merchant application 244 may receive one or more tokens as a payment vehicle for a transaction at the merchant. The merchant application 244 may recognize that the merchant system 206 does not have the infrastructure capabilities to process the token appropriately. Furthermore, the merchant application 244 may recognize code embedded within the token that enables the merchant application 244 to push the token to the system server 208 for payment processing. In this way, the merchant application 244 doesn't reject the token as a form of payment for the transaction. The ability to read the code embedded within the token may have been provided to the merchant application 244 and stored in the memory device 240 from the system server 208.

It is understood that the servers, systems, and devices described herein illustrate one embodiment of the invention. It is further understood that one or more of the servers, systems, and devices can be combined in other embodiments and still function in the same or similar way as the embodiments described herein.

The present invention relates to tokenization, which is generally described in the area of financial transactions as utilizing a “token” (e.g., an alias, substitute, surrogate, or other like identifier) as a replacement for sensitive account information, and in particular account numbers. As such, tokens or portions of tokens may be used as a stand in for a user account number, user name, pin number, routing information related to the financial institution associated with the account, security code, or other like information relating to the user account. The one or more tokens may then be utilized as a payment instrument to complete a transaction. The one or more tokens may be associated with one or more payment devices directly, or within one or more digital wallets associated with the payment devices. In other embodiments, the tokens may be associated with electronic transactions that are made over the Internet instead of using a physical payment device. Utilizing a token as a payment instrument instead of actual account information, and specifically an account number improves security, and provides flexibility and convenience in controlling the transactions, controlling accounts used for the transactions, and sharing transactions between various users.

Tokens may be single-use instruments or multi-use instruments depending on the types of controls (e.g., limits) initiated for the token, and the transactions in which the token is used as a payment instrument. Single-use tokens may be utilized once, and thereafter disappear or are erased, while multi-use tokens may be utilized more than once before they disappear or are erased.

Tokens may be 16-digit numbers like credit, debit, or other like account numbers, may be numbers that are less than 16-digits, or may contain a combination of numbers, symbols, letters, or the like, and be more than, less than, or equal to 16-characters. In some embodiments, the tokens may have to be 16-characters or less in order to be compatible with the standard processing systems between merchants, acquiring financial institutions (e.g., merchant financial institution), card association networks (e.g., card processing companies), issuing financial institutions (e.g., user financial institution), or the like, which are used to request authorization, and approve or deny transactions entered into between a merchant and a user. In other embodiments of the invention, the tokens may be other types of electronic information (e.g., pictures, codes, or the like) that could be used to enter into a transaction instead of, or in addition to, using a string of characters (e.g., numbered character strings, alphanumeric character strings, symbolic character strings the like).

A user may have one or more digital wallets on the user's payment device. The digital wallets may be associated specifically with the user's financial institution, or in other embodiments may be associated with a specific merchant, group of merchants, or other third parties. The user may associate one or more user accounts (e.g., from the same institution or from multiple institutions) with the one or more digital wallets. In some embodiments, instead of the digital wallet storing the specific account number associated with the user account, the digital wallet may store a token or allow access to a token in order to represent the user account information (e.g., account number, user name, pin number, or the like). In other embodiments of the invention, the digital wallet may store some or all of the user account information, including the user account number, but presents the one or more tokens instead of the user account information when entering into a transaction with a merchant. The merchant may be a business, a person that is selling a good or service (hereinafter “product”), or any other institution or individual with which the user is entering into a transaction.

The digital wallet may be utilized in a number of different ways. For example, the digital wallet may be a device digital wallet, a cloud digital wallet, an e-commerce digital wallet, or another type of digital wallet. In the case of a device digital wallet the tokens are actually stored on the payment device. When the device digital wallet is used in a transaction the token stored on the device is used to enter into the transaction with the merchant. With respect to a cloud digital wallet the device does not store the token, but instead the token is stored in the cloud of the provider of the digital wallet (or another third party). When the user enters into a transaction with a merchant, transaction information is collected and provided to the owner of the cloud to determine the token, and thus how the transaction should be processed. In the case of an e-commerce digital wallet, a transaction is entered into over the Internet and not through a point of sale terminal. As was the case with the cloud digital wallet, when entering into a transaction with the merchant over the Internet the transaction information may be captured and transferred to the wallet provider (e.g., in some embodiment this may be the merchant) or another third party that stores the token, and the transaction may be processed accordingly.

Specific tokens, in some embodiments, may be tied to a single user account, but in other embodiments, may be tied to multiple user accounts, as will be described throughout this application. Moreover, the tokens may be associated with a specific digital wallet or multiple digital wallets based on the institutions and accounts with which the tokens may be associated. Moreover, the tokens themselves, or the user accounts, users, digital wallets, or the like associated with the tokens may have limitations that limit the transactions that the users may enter into using the tokens. The limitations may include, limiting the transactions of the user to a single merchant, a group of multiple merchants, merchant categories, single products, a group a products, product categories, transaction amount limits, transaction numbers, geographic locations, or other like limits as is described herein.

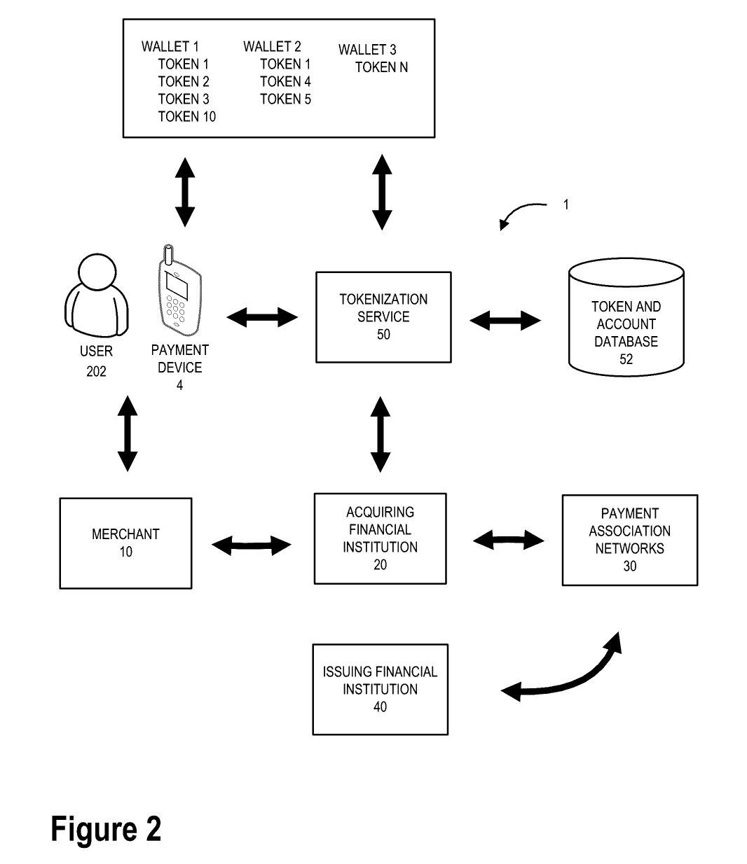

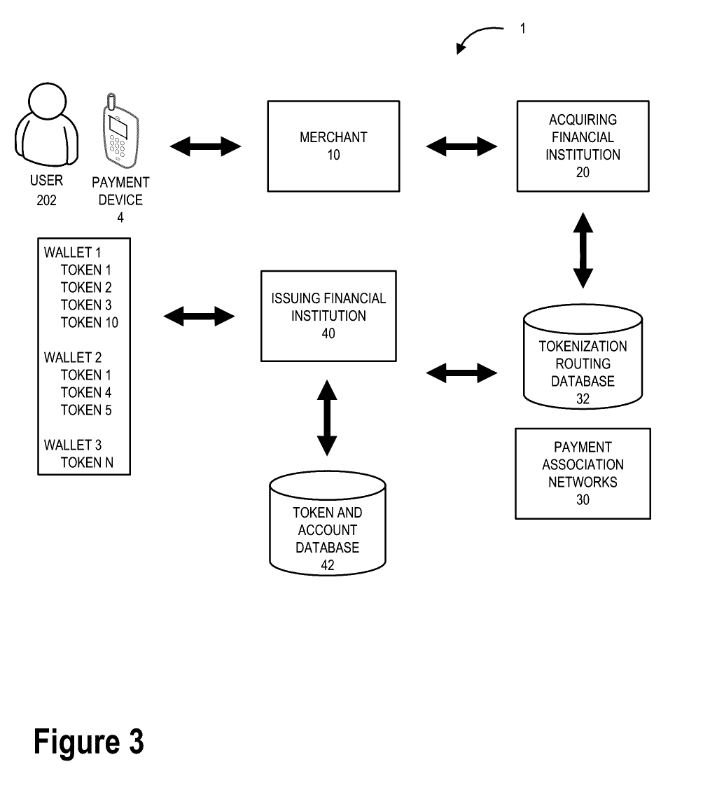

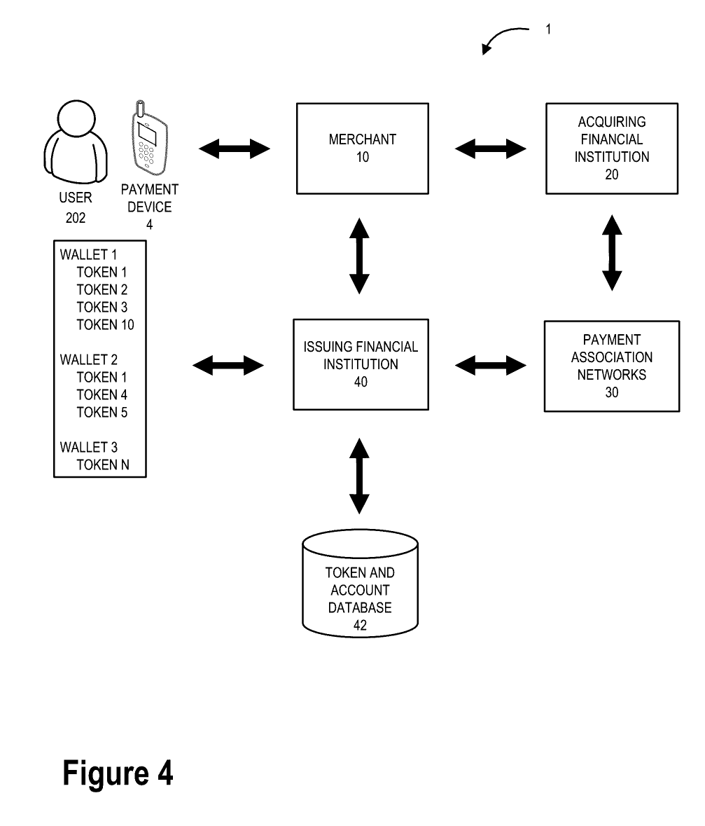

FIGS. 2 through 4 illustrate a number of different ways that the user 202 may use one or more tokens in order to enter into a transaction and make payments associated with the transaction. FIG. 2, illustrates one embodiment of a token system process 1, wherein the token system process 1 is used in association with a tokenization service 50. The tokenization service 50 may be provided by a third-party institution, the user's financial institution, or another institution involved in a transaction payment process. As illustrated in FIG. 2 (as well as in FIGS. 3 and 4), a user 202 may utilize a payment device 4 (or in other embodiments a payment instrument over the Internet) to enter into a transaction. FIG. 2 illustrates the payment device 4 as a mobile device, such as a smartphone, personal digital assistant, or other like mobile payment device. Other types of payment devices 4 may be used to make payments, such as but not limited to an electronic payment card, key fob, a wearable payment device (e.g., watch, glasses, or the like). As such, when using a payment device 4 the transaction may be made between the point of sale (POS) and the payment device 4 by scanning information from the payment device 4, using near field communication (NFC) between the POS and the payment device 4, using wireless communication between the POS and the payment device 4, or using another other type of communication between the POS and the payment device 4. When entering into an e-commerce transaction over the Internet, for example using the payment device 4 or another device without a POS, a payment instrument may be used to enter into the transaction. The payment instrument may be the same as the token or digital wallet associated with the payment device 4, except they are not associated with specific payment device. For example, the token or digital wallet may be associated with an application that can be used regardless the device being used to enter into the transaction over the Internet.

The token can be associated directly with the payment device 4, or otherwise, through one or more digital wallets associated with the payment device 4. For example, the token may be stored on one or more payment devices 4 directly, and as such any transaction entered into by the user 202 with the one or more payment devices 4 may utilize the token. Alternatively, the payment device 4 may have one or more digital wallets stored on the payment device 4 that allow the user 202 to store one or more user account numbers, or tokens associated with the user account numbers, on the one or more digital wallets. The user may select a digital wallet or account within the digital wallet in order to enter into a transaction using a specific type of customer account. As such, the digital wallets may be associated with the user's issuing financial institutions 40, other financial institutions, merchants 10 with which the user enters into transactions, or a third party institutions that facilitates transactions between users 202 and merchants 10.

As illustrated in FIG. 2, a tokenization service 50 may be available for the user 202 to use during transactions. As such, before entering into a transaction, the user 202 may generate (e.g., create, request, or the like) a token in order to make a payment using the tokenization service 50, and in response the tokenization service 50 provides a token to the user and stores an association between the token and the user account number in a secure token and account database 52. The token may be stored in the user's payment device 4 (e.g., on the digital wallet) or stored on the cloud or other service through the tokenization service 50. The tokenization service 50 may also store limits (e.g., geographic limits, transaction amount limits, merchant limits, product limits, or the like) associated with the token that may limit the transactions in which the user 202 may enter. The limits may be placed on the token by the user 202, or another entity (e.g., person, company, or the like) responsible for the transactions entered into by the user 202 using the account associated with the token. The generation of the token may occur at the time of the transaction or well in advance of the transaction, as a one-time use token or multi-use token.

After or during creation of the token the user 202 enters into a transaction with a merchant 10 using the payment device 4 (or payment instrument over the Internet). In some embodiments the user 202 may use the payment device 4 by itself, or specifically select a digital wallet or user account stored within the digital wallet, to use in order to enter into the transaction. The token associated with payment device, digital wallet, or user account within the wallet is presented to the merchant 10 as payment in lieu of the actual user account number and/or other user account information. The merchant 10 receives the token, multiple tokens, and/or additional user account information for the transaction. The merchant 10 may or may not know that the token being presented for the transaction is a substitute for a user account number or other user account information. The merchant also captures transaction information (e.g., merchant, merchant location, transaction amount, product, or the like) related to the transaction in which the user 202 is entering with the merchant 10.

The merchant 10 submits the token (as well as any user account information not substituted by a token) and the transaction information for authorization along the normal processing channels (also described as processing rails), which are normally used to process a transaction made by the user 202 using a user account number. In one embodiment of the invention the acquiring financial institution 20, or any other institution used to process transactions from the merchant 10, receives the token, user account information, and transaction information from the merchant 10. The acquiring financial institution 20 identifies the token as being associated with a particular tokenization service 50 through the token itself or user account information associated with the token. For example, the identification of the tokenization service 50 may be made through a sub-set of characters associated with the token, a routing number associated with the token, other information associated with the token (e.g., tokenization service name), or the like. The acquiring financial institution 20 may communicate with the tokenization service 50 in order to determine the user account number associated with the token. The tokenization service 50 may receive the token and transaction data from the acquiring financial institution 20, and in response, provide the acquiring financial institution 20 the user account number associated with the token as well as other user information that may be needed to complete the transaction (e.g., user name, issuing financial institution routing number, user account number security codes, pin number, or the like). In other embodiments, if limits have been placed on the token, the tokenization service 50 may determine whether or not the transaction information meets the limits and either allows or denies the transaction (e.g., provides the user account number or fails to provide the user account number). The embodiment being described is when the token is actually stored on the payment device 4. In other embodiments, for example, when the actual token is stored in a cloud the payment device 4 may only store a link to the token or other token information that allows the merchant 10 or acquiring financial institution to acquire the token from a stored cloud location.

If the acquiring financial institution 20 receives the user account number from the tokenization service 50 (e.g., the transaction is allowed), then the acquiring financial institution 20 thereafter sends the user account number, the other user information, and the transaction information directly to the issuing financial institution 40, or otherwise indirectly through the card association networks 30. The financial institution determines if the user 202 has the funds available to enter into the transaction, and if the transaction meets other limits on the user account, and responds with approval or denial of the transaction. The approval runs back through the processing channels until the acquiring financial institution 20 provides approval or denial of the transaction to the merchant 10 and the transaction between the merchant 10 and the user 202 is completed. After the transaction is completed the token may be deleted, erased, or the like if it is a single-use token, or stored for further use if it is a multi-use token.

The embodiment illustrated in FIG. 2 prevents the user account number and other user information from being presented to the merchant 10; however, the tokenization service 50, acquiring financial institution 20, the card association networks 30, and the issuing financial institution 40 all utilize the actual user account number and other user information to complete the transaction.

FIG. 3 illustrates another embodiment of a token system 1, in which the user 202 may utilize a payment device 4 (or payment instrument over the Internet) to enter into transactions with merchants 10 utilizing tokens instead of user account numbers. As illustrated in FIG. 3, the user may have one or more tokens, which may be associated with the payment device 4, one or more digital wallets within the payment device 4, or one or more user accounts associated with the digital wallets. The one or more tokens may be stored in the user's payment device 4 (or on the digital wallet), or stored on a cloud or other service through the issuing financial institution 40 or another institution. The user 202 may set up the digital wallet by communicating with the issuing financial institution 40 (e.g., the user's financial institution) to request a token for the payment device, either for the device itself, or for one or more digital wallets or one or more user accounts stored on the payment device. As previously discussed, a wallet may be specifically associated with a particular merchant (e.g., received from the merchant 10) and include one or more tokens provided by the issuing financial institution 40 directly (or through the merchant as described with respect to FIG. 4). In other embodiments, the issuing financial institution 40 may create the digital wallet for the user 202 (e.g., for through a wallet created for a business client or retail client associated with the user 202) and include one or more tokens for various types of transactions, products, or the like. The issuing financial institution 40 may store the tokens, the associated user account information (e.g., including the user account number), and any limits on the use of the token, as was previously described with respect to the tokenization service 50. In one embodiment the tokens may include user account information or routing information within the token or tied to the token, which allows the merchants 10 and other institutions in the payment processing systems to route the token and the transaction information to the proper institutions for processing. In other embodiments a tokenization routing database 32 may be utilized to determine where to route a transaction using a token, as described in further detail later.

The user 202 may enter into a transaction with the merchant 10 using a payment device 4 (or a payment instrument through the Internet). In one embodiment the user 202 may enter into the transaction with a token associated with the payment device 4 itself (or a payment instrument through the Internet). In other embodiments, a specific digital wallet and/or a specific account within the digital wallet may be selected for a particular merchant with whom the user 202 wants to enter into a transaction. For example, the user 202 may select “wallet 1” to enter into a transaction with “merchant 1” and “token 1” to utilize a specific account. The merchant 10 identifies the token, and sends the token and the transaction information to the acquiring financial institution 20. If the token has routing information the acquiring financial institution 20 may route the token and transaction data to the issuing financial institution 40 directly or through the card association networks 30. In situations where the token does not have associated routing information, the acquiring financial institution 20 may utilize a tokenization routing database 32 that stores tokens or groups of tokens and indicates to which issuing financial institutions 40 the tokens should be routed. One or more of the acquiring financial institutions 20, the card association networks 30, and/or the issuing financial institutions 40 may control the tokenization routing database in order to assign and manage routing instructions for tokenization across the payment processing industry. The tokenization routing database 32 may be populated with tokens and the corresponding issuing financial institutions 40 to which transactions associated with the tokens should be routed.

Once the token and transaction details are routed to the issuing financial institution 40, the issuing financial institution 20 determines the user account associated with the token through the use of the token account database 42. The financial institution determines if the funds are available in the user account for the transaction and if the transaction information meets other limits by comparing the transaction information with the limits associated with the token or the user account associated with the token. If the transaction meets the limits associated with the token or user account, then the issuing financial institution 20 allows the transaction. If the transaction information does not meet one or more of the limits, then the issuing financial institution 20 denies the transaction. The issuing financial institution sends a notification of the approval or denial of the transaction back along the channels of the transaction processing system to the merchant 10, which either allows or denies the transaction.

The embodiment illustrated in FIG. 3 allows the user and the financial institution to shield the user's account number and other user information from all of the entities in the payment processing system because the merchant 10, acquiring merchant bank 20, payment association networks 30, or other institutions in the payment processing system only used the token and/or other shielded user information to process the transaction. Only the issuing financial institution 40 has the actual account number of the user 202.

FIG. 4 illustrates another embodiment of the token system 1, in which the user 202 may utilize a payment device 4 (or payment instrument over the Internet) to enter into transactions with a merchant 10 utilizing a token instead of a user account number and/or other user account information. As illustrated in FIG. 4, the user 202 may have one or more tokens stored in the payment device 4, which may be associated with one or more digital wallets, or one or more user accounts within the digital wallets. The one or more tokens may be stored in the user's payment device 4 (or on the digital wallet), or stored on a cloud or other service through the issuing financial institution 40 or another institution. The user 202 may set up the digital wallet by communicating with the issuing financial institution 40 (e.g., the user's financial institution) and/or the merchant 10 to request a token for the payment device 4, either for the device itself, for the one or more digital wallets stored on the payment device 4, or for user accounts within the digital wallet. The financial institution 40 may have a dedicated group of tokens that are associated with a specific merchant, and as such the merchant 10 and the issuing financial institution 40 may communicate with each other to provide one or more tokens to the user 202 that may be specifically associated with the merchant 10. For example, the issuing financial institution may provide a set of tokens to “merchant 1” to associate with “wallet 1” that may be used by one or more users 202. As such “Token 10” may be associated with “wallet 1” and be specified only for use for transactions with “merchant 1.”

The merchant 10 may provide the specific tokens from the financial institution 40 to the user 202, while the financial institution 40 may store the user account information with the token provided to the user 202. The financial institution may communicate directly with the user 202, or through the merchant 10 in some embodiments, in order to associate the token with the user 202. Since the merchant 10 provides, or is at least notified by the financial institution 40, that a specific token, or groups of tokens, are associated with a specific issuing financial institution 40, then the merchant 10 may associate routing information and transaction information with the token when the user 202 enters into a transaction with the merchant 10 using the token.

The merchant 10 passes the token (and potentially other user account information), routing information, and transaction information to the acquiring financial institution 20 using the traditional payment processing channels. The acquiring financial institution 20, in turn, passes the token (and potentially other user account information) and transaction information directly to the issuing financial institution 40, or indirectly through the payment association networks 30 using the routing information. The issuing financial institution 40 accesses the token and account database 42 to identify the user account associated with the token and determines if the transaction information violates any limits associated with the token or the user account. The issuing financial institution 40 then either approves or denies the transaction and sends the approval or denial notification back through the payment processing system channels to the merchant 10, which then notifies the user 202 that the transaction is allowed or denied.

As is the case with the token system 2 in FIG. 3, the token system in FIG. 4 allows the user 202 and the financial institution 40 to shield the user's account number and other user information from all of the entities in the payment processing system because the merchant 10, acquiring merchant bank 20, payment association networks 30, or other institutions in the payment processing system only use the token and/or other shielded user information to process the transaction. Only the issuing financial institution 40 has the actual account number of the user 202.

The embodiments of the invention illustrated in FIGS. 2 through 4 are only example embodiments of the invention, and as such it should be understood that combinations of these embodiments, or other embodiments not specifically described herein may be utilized in order to process transactions between a user 202 and merchant 10 using one or more tokens as a substitute for user account numbers or other user account information, such that the merchant, or even other institutions in the payment processing system do not have access to the actual user accounts or account information.

As briefly discussed above, if the issuing financial institution 40 creates the digital wallet not only does the financial institution 40 receive transaction information along the normal processing channels, but the financial institution 50 may also receive additional transaction information from the user 202 through the digital wallet using the application program interfaces (APIs) or other application created for the digital wallet. For example, geographic location information of the user 202, dates and times, product information, merchant information, or any other information may be transmitted to the issuing financial institution 40 through the APIs or other applications to the extent that this information is not already provided through the normal transaction processing channels. This additional transaction information may assist in determining if the transactions meet or violate limits associated with the tokens, user accounts, digital wallets, or the like.

Alternatively, if the merchant 10 or another institution, other than the issuing financial institution 40, provides the digital wallet to the user 202, the issuing financial institution 40 may not receive all the transaction information from the traditional transaction processing channels or from the digital wallet. As such, the issuing financial institution 40 may have to receive additional transaction information from another application associated with the user 202 and compare the transaction information received through the traditional channels in order to associate the additional information with the transaction. In other embodiments, the issuing financial institutions 40 may have partnerships with the merchants 10 or other institutions to receive additional transaction information from the digital wallets provided by the merchants or other institutions when the user enters into transactions using the digital wallets.

Moreover, when there is communication between the digital wallets of the users 202 and the issuing financial institution 40 or another institution, transactions in which the user 202 may enter may be pre-authorized (e.g., pre-qualified) to determine what accounts (e.g., tokens) may be used to complete the transaction, without having to arbitrarily choose an account for the transaction. In the case when there are multiple digital wallets or multiple accounts, the account that is pre-authorized or the account that provides the best rewards may be automatically chosen to complete the transactions.

Additional embodiments of the invention will now be described in further detail in order to provide additional concepts and examples related to how tokens may be utilized in these illustrated token system processes 1 or in other token system processes not specifically described in FIGS. 2 through 4.

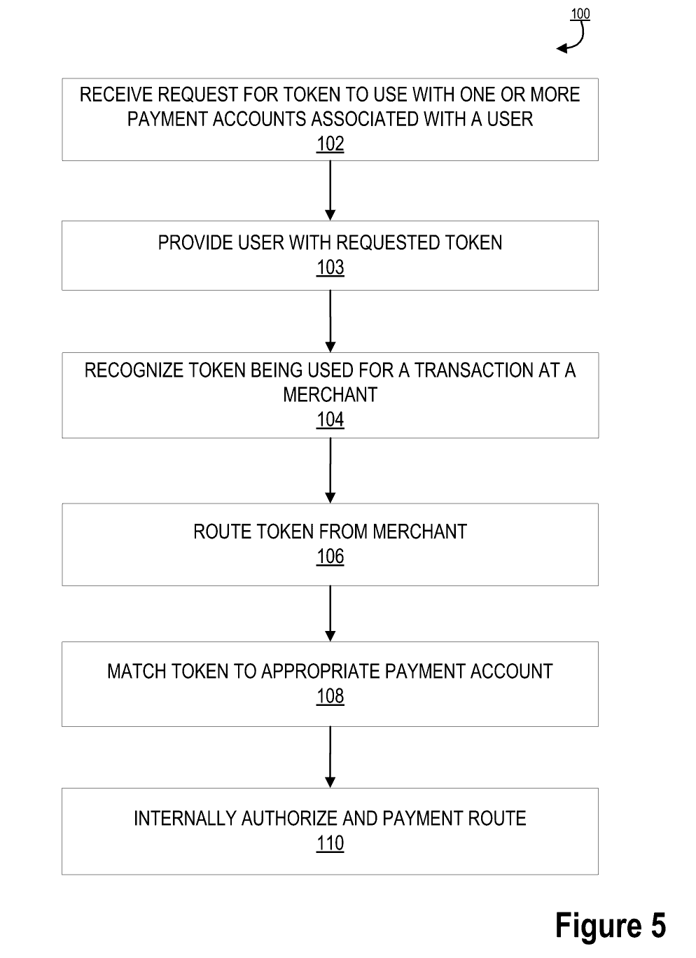

FIG. 5 provides a high level process flow illustrating the non-infrastructural changing tokenization migration system process 100, in accordance with one embodiment of the present invention. As illustrated in block 102, the process is initiated by receiving a request for a token to be used with one or more payment accounts associated with a user. In this way, the user may have one or more payment accounts such as a credit card account, a debit card account, a checking account, or the like. The user may desire that one or more of these accounts to be associated with a mobile means of transacting, such as a mobile wallet or other digital or mobile methods of transacting. In some embodiments, the token may comprise information for a soft or virtual credit card for use via digital wallet. In some embodiments, the system may provide the token to the digital wallet. The token may be stored in the memory of the user device associated with the digital wallet. The token may include a virtual image of the card, card number, CVV number, expiration data, and other disclosures of the card required to utilize the card for digital wallet transactions. In yet other embodiments, the token may comprise a unique token number and no identifiable information on it. In this way, the system may associate the token with an account after the token has been used for a transaction, thus preventing account number dissemination.

Next, as illustrated in block 103, the system may generate and provide the user with a token based on the user's request. The token may comprise unique code established therein to direct the token to the system infrastructure upon use. The token may be stored within the user's mobile device, stored in a plastic card, or the like.

As illustrated in block 104, the system may then recognize the token being implemented for a transaction at a merchant. The code associated with the token is recognized by the merchant as data points for routing the token to the system. While the merchant systems are not capable of processing a token for payment because of the merchant's infrastructure, system stored modules on the merchant system may recognize the token and code associated thereon, thus allowing the merchant to route the token to the system for payment processing. In this way, allowing a merchant to complete a transaction that the merchant may otherwise not be able to complete. As illustrated in block 106, code associated with the token may allowing the token to be routed from the merchant to the system. In some embodiments, the merchant may be capable of reading a portion of code on the token and based on that code, route the token. In other embodiments, once the token is used for a transaction the token, based on specific routing programming code associated therewith may automatically be directed to the system from the merchant for processing without merchant reading or interaction. Furthermore, the merchant may also send, along with the token, merchant data, which includes a merchant identification, a category code for the merchant, a total price of the transaction, and the like.

Once the system receives the token from the merchant, the system may match the token to the appropriate payment account, as illustrated in block 108. In this way, the token may have one or more codes associated therewith. One of those codes may comprise a token number. The token number may correspond to at least one payment account. When the system receives the token from the merchant, the system may match the token number with a previously coordinated payment account number associated with that token number. Using this payment account number, the system may, via its infrastructure, authorize the transaction and provide the appropriate payment routing, as illustrated in block 110.

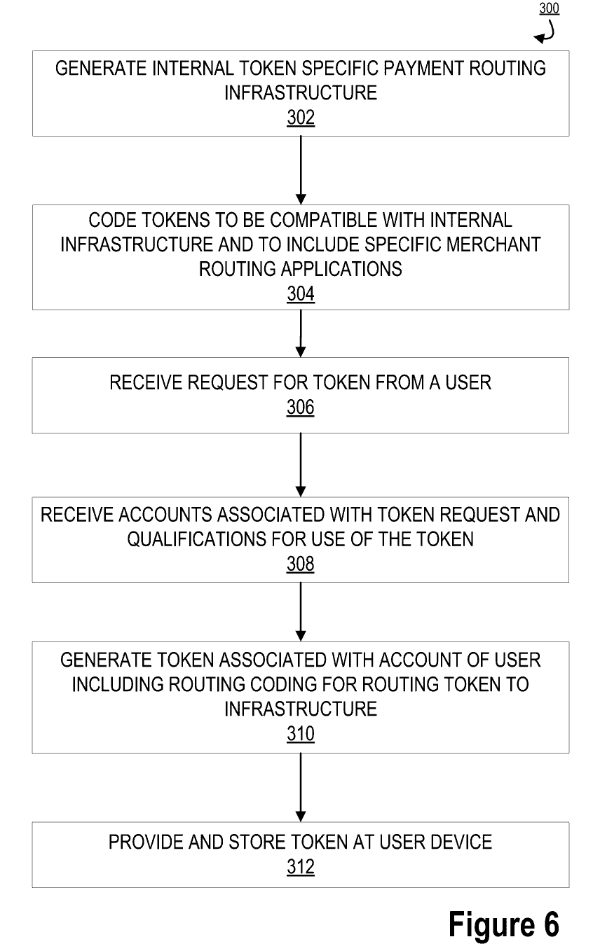

FIG. 6 illustrates a process map for coding and generating a token for transaction utilization 300, in accordance with one embodiment of the present invention. The process 300 is initiated by generating an internal token specific payment routing infrastructure, as illustrated in block 302. The system builds an infrastructure capable of reading and providing payment routing for token based payments received at any merchant. As illustrated in block 304, the tokens are generated and coded to be compatible with the internal infrastructure created and to include specific merchant routing applications. In some embodiments, the merchant system may be capable of reading the routing application or codes on the token and routing the token to the system infrastructure. In other embodiments, the token may, via the routing application recognized it has been transferred to a merchant and automatically route to the system infrastructure for payment processing.

Next, as illustrated in block 306, the process 300 may continue by receiving a request for a token from a user. In this way, the user may desire to complete a transaction using NFC, digital wallet, or other digital or alternative payment methods using a token. As illustrated in block 308, the system may also receive the accounts associated with the token requested and the qualification for use of the token from the user. In this way, the request may also include user preferences, such as an account number to associate with the token, a time frame for activation of the token, one or more designated merchants for the token, one or more users that may have access to the token, and/or the like.

As illustrated in block 310, the system may generate a token associated with an account of the user that includes routing coding for routing the token to the generated infrastructure. Finally, as illustrated in block 312, the system may provide the token to a user and store the token on the user's device.

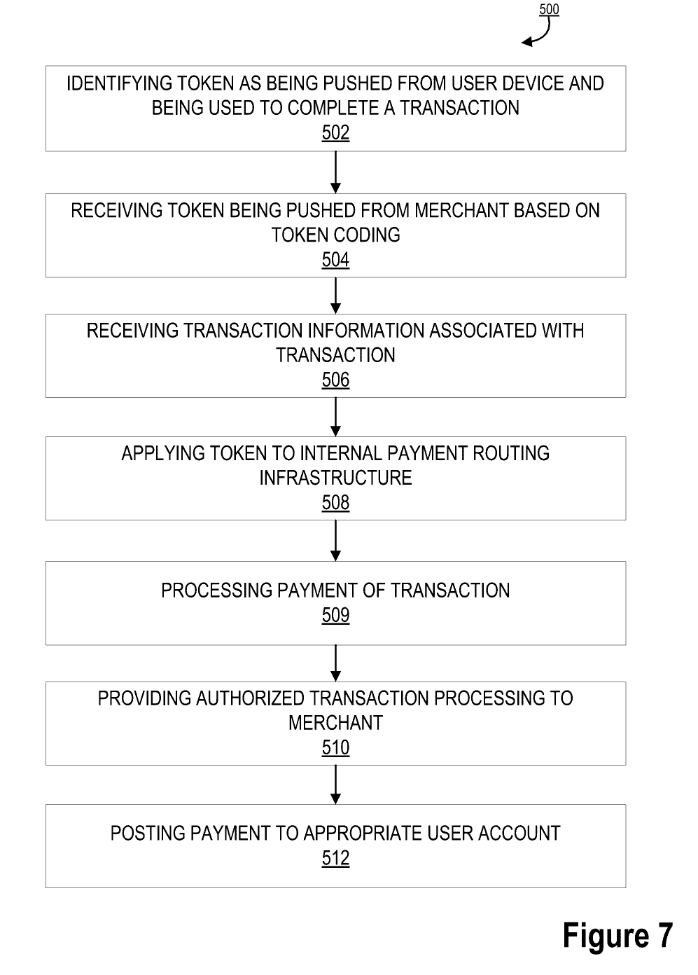

FIG. 7 illustrates a process map for utilizing a token to complete a transaction and posting of the transaction 500, in accordance with one embodiment of the present invention. As illustrated in block 502, the process 500 is initiated by identifying a token as being pushed from the user device to a merchant to complete a transaction. In this way, the user may be attempting to complete a transaction using a mobile wallet or the like. The user device may push the token to a merchant device as a payment for a transaction with the merchant. At this point, the merchant infrastructure may not be compatible with the token and, as such, may not be able to continue to process the token for transaction payment.

In some embodiments, the token may be previously coded for identification and sending to the system generated infrastructure. In this way, as illustrated in block 504, the token is received from the merchant based on the token being coded for forwarding to the system infrastructure. In some embodiments, the merchant may read and recognize the routing code associated with the token to route the token to the system. In other embodiments, the token may recognize its transfer or push to the merchant and automatically re-route itself to the system for processing via the internally created infrastructure. Furthermore, the merchant may also send, along with the token, merchant data, which includes a merchant identification, a category code for the merchant, a total price of the transaction, and the like.

As illustrate in block 506, the system may, based on receiving the token, receiving transaction information associated with the transaction. This information may include details about the merchant, location, products purchased, and total purchase price of the transaction. In some embodiments, the transaction information may be received with the token. In other embodiments, the transaction information may be sent to the system independent of the token.

Next, as illustrated in block 508, the process continues by applying the token to the internal payment infrastructure. This infrastructure allows the system to process a token payment that the merchant may not be capable of processing. Next, as illustrated in block 510, after processing the token via the internal payment infrastructure, the system may provide authorized transaction processing to the merchant such that the merchant and user can finalize the transaction. Finally, after providing authorization to complete the transaction to the merchant, the system may post the transaction to the appropriate user account, as illustrated in block 512.

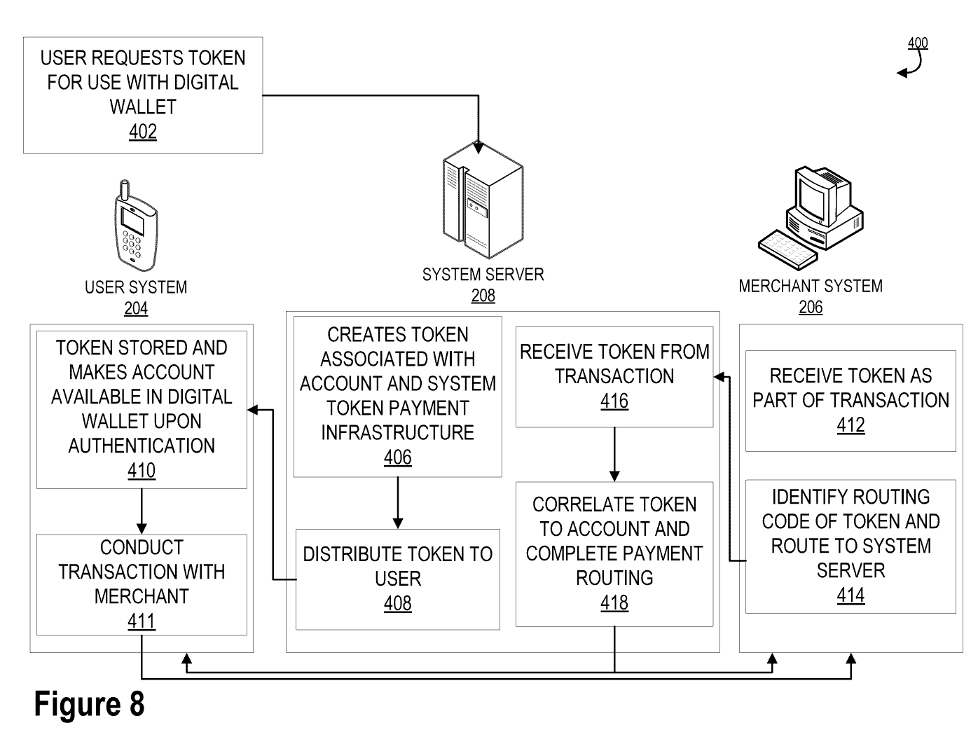

FIG. 8 illustrates a process map for system integration, data flow, and data transformation of the tokenization migration system 400, in accordance with one embodiment of the present invention. As illustrated in bock 402, the process 400 is initiated when the user requests a token for use with a digital wallet. The request is identified and sent to the system server 208 for processing. The system server 208 may first create or have previously created a payment infrastructure for routing and finalizing payments via a token. The system server 208 may create a token associated with the account and associate that token with the system token infrastructure, as illustrated in block 406. Once the token is created and coded for the infrastructure, the user account, and the user authentication requirements (requirements for one time use token, merchant specific token, time specific token, or the like). The system server 208 may communicate the token to the user system 204. The system server 208 may store the token in the user system 204 and make it available in a digital wallet upon user authentication, as illustrated in block 410.

As illustrated in block 411, the user system 204 may conduct a transaction with a merchant and push the token to the merchant as payment for the transaction. The token is then pushed to the merchant system 206 as part of the transaction process. As illustrated in block 412, the merchant system 206 may receive the token. The merchant system 206 may then recognize that it is incapable of processing the token. In this way the merchant system 206 may identify the routing code associated with the token and route the token to the system server, as illustrated in block 414. In some embodiments the token may automatically, upon being pushed to the merchant system 206 route itself to the system server 208 for processing.

Next, as illustrated in block 416, the system server 208 may receive the token from the transaction. Associated with or incorporated within the token may include information about the transaction, such as the merchant, products of the transaction, and a total payment for the transaction. The received token is then correlated to an account associated with the user and the system server 208 completes the payment routing and processing process, as illustrated in block 418. The system server 208 may also provide the authorized transaction and proof of completion of payment routing to the merchant system 206 and the user system 204.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function. As such, once the software and/or hardware of the claimed invention is implemented the computer device and application-specific circuits associated therewith are deemed specialized computer devices capable of improving technology associated with the in authorization and instant integration of a new credit card to digital wallets.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a special purpose computer for the authorization and instant integration of credit cards to a digital wallet, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. patent | | |
|---|---|---|---|
| | application | | Filed |
| Docket Number | Ser. No. | Title | On |
| 6859US1.014033.2533 | To Be | TOKENIZATION | Concur- |
| | Assigned | PROVISIONING | rently |
| | | AND ALLOCATING | Herewith |
| | | SYSTEM | |
| 6860US1.014033.2534 | To Be | NON-INTRUSIVE | Concur- |
| | Assigned | GEO-LOCATION | rently |
| | | DETERMINATION | Herewith |
| | | ASSOCIATED WITH | |
| | | TRANSACTION | |
| | | AUTHORIZATION | |
| 6860US2.014033.2535 | To Be | NON-INTRUSIVE | Concur- |
| | Assigned | GEO-LOCATION | rently |
| | | DETERMINATION | Herewith |
| | | ASSOCIATED WITH | |
| | | TRANSACTION | |
| | | AUTHORIZATION | |
| 6803US1.014033.2557 | To Be | SYSTEM FOR | Concur- |
| | Assigned | ELECTRONIC COL- | rently |
| | | LECTION AND | Herewith |
| | | DISPLAY OF | |
| | | ACCOUNT TOKEN | |
| | | USAGE AND | |
| | | ASSOCIATION | |
| 6861US1.014033.2537 | To Be | TOKEN PROVI- | Concur- |
| | Assigned | SIONING FOR | rently |
| | | NON-ACCOUNT | Herewith |
| | | HOLDER USER | |
| | | WITH LIMITED | |
| | | TRANSACTION | |
| | | FUNCTIONS | |
| 6862US1.014033.2538 | To Be | ACCOUNT | Concur- |
| | Assigned | TOKENIZATION | rently |
| | | FOR VIRTUAL | Herewith |
| | | CURRENCY | |
| | | RESOURCES | |

What is claimed is:

1. A system for tokenization migration, the system comprising:
a memory device with non-transitory computer-readable program code stored thereon;
a communication device;
a processing device operatively coupled to the memory device and the communication device within a distributive network for the approval, wherein the processing device is configured to execute the computer-readable program code to:
generate a token specific infrastructure, wherein the infrastructure includes routing and payment processing applications;
receive, via a distributive network, a request from a user device for a token to be communicated to and implemented in a payment vehicle;
code the token, based on the request, to be compatible with the infrastructure, wherein the token includes code for merchant routing instructions to the infrastructure and user qualifications for the token;
send the token to the user device via a secure communicable link and store the token on the payment vehicle;
identify the token being pushed from the payment vehicle to a merchant system as part of a transaction;
retrieve, based on the identification of the token being pushed to the merchant system, the token;
correlate the token to a stored account number associated with a payment account;
apply the token to the infrastructure and processing a payment via the payment processing application for authorization of the transaction; and
communicate approved payment authorization processing to the merchant and the user to allow completion of the transaction.

2. The system of claim 1, wherein merchant routing instructions further comprise instructions to route the token to the infrastructure upon being pushed to the merchant system for a transaction, wherein the merchant routing instructions include instructions to route transaction information including a total payment due for the transaction.

3. The system of claim 1, wherein user qualifications for the token comprise limitations for using the token based on merchant, time frame, or amount of the transaction.

4. The system of claim 1, wherein the payment vehicle is the user device or a microchip associated with a card.

5. The system of claim 1, wherein identifying the token being pushed from the payment vehicle to a merchant system further comprises receiving coded data from the token that the token is being pushed to a merchant system.

6. The system of claim 1, wherein retrieving the token further comprises retrieving transaction information including the merchant address, products of the transaction, a price for each of the products of the transaction, and a total payment due for the transaction.

7. The system of claim 1, wherein the token specific infrastructure comprises components for:
generating tokens with program code for routing the tokens to the infrastructure; and
routing, after the transaction has been initiated, the token to an appropriate payment routing application based on an identification of the account number associated with the payment account.

8. The system of claim 1, further comprising performing condition diagnostics on the user device prior to sending the user device the token, wherein performing condition diagnostics comprises determining a security confidence rating for integration of the token to the payment vehicle, wherein the security confidence rating confirms that no malware is present on the user device prior to sending the token.

9. A computer program product for tokenization migration, the computer program product, within a distributive network for the convergence and divergence analysis, comprising at least one non-transitory computer-readable medium having computer-readable program code portions embodied therein, the computer-readable program code portions comprising:
an executable portion configured for generating a token specific infrastructure, wherein the infrastructure includes routing and payment processing applications;
an executable portion configured for receiving, via a distributive network, a request from a user device for a token to be communicated to and implemented in a payment vehicle;
an executable portion configured for coding the token, based on the request, to be compatible with the infrastructure, wherein the token includes code for merchant routing instructions to the infrastructure and user qualifications for the token;
an executable portion configured for ending the token to the user device via a secure communicable link and store the token on the payment vehicle;
an executable portion configured for identifying the token being pushed from the payment vehicle to a merchant system as part of a transaction;
an executable portion configured for retrieving, based on the identification of the token being pushed to the merchant system, the token;
an executable portion configured for correlating the token to a stored account number associated with a payment account;
an executable portion configured for applying the token to the infrastructure and processing a payment via the payment processing application for authorization of the transaction; and
an executable portion configured for communicating approved payment authorization processing to the merchant and the user to allow completion of the transaction.

10. The computer program product of claim 9, wherein merchant routing instructions further comprise instructions to route the token to the infrastructure upon being pushed to the merchant system for a transaction, wherein the merchant routing instructions include instructions to route transaction information including a total payment due for the transaction.

11. The computer program product of claim 9, wherein user qualifications for the token comprise limitations for using the token based on merchant, time frame, or amount of the transaction.

12. The computer program product of claim 9, wherein the payment vehicle is the user device or a microchip associated with a card.

13. The computer program product of claim 9, wherein identifying the token being pushed from the payment vehicle to a merchant system further comprises receiving coded data from the token that the token is being pushed to a merchant system.

14. The computer program product of claim 9, wherein retrieving the token further comprises retrieving transaction information including the merchant address, products of the transaction, a price for each of the products of the transaction, and a total payment due for the transaction.

15. The computer program product of claim 9, wherein the token specific infrastructure comprises components for:
generating tokens with program code for routing the tokens to the infrastructure; and
routing, after the transaction has been initiated, the token to an appropriate payment routing application based on an identification of the account number associated with the payment account.

16. The computer program product of claim 9, further comprising an executable portion configured for performing condition diagnostics on the user device prior to sending the user device the token, wherein performing condition diagnostics comprises determining a security confidence rating for integration of the token to the payment vehicle, wherein the security confidence rating confirms that no malware is present on the user device prior to sending the token.

17. A computer-implemented method for tokenization migration, the method comprising:
providing a computing system within a distributive network for the authorization and instant integration approval for a digital wallet, comprising a computer processing device and a non-transitory computer readable medium, where the computer readable medium comprises configured computer program instruction code, such that when said instruction code is operated by said computer processing device, said computer processing device performs the following operations:
generating a token specific infrastructure, wherein the infrastructure includes routing and payment processing applications;
receiving, via a distributive network, a request from a user device for a token to be communicated to and implemented in a payment vehicle;
coding the token, based on the request, to be compatible with the infrastructure, wherein the token includes code for merchant routing instructions to the infrastructure and user qualifications for the token;
sending the token to the user device via a secure communicable link and store the token on the payment vehicle;
identifying the token being pushed from the payment vehicle to a merchant system as part of a transaction;
retrieving, based on the identification of the token being pushed to the merchant system, the token;
correlating the token to a stored account number associated with a payment account;
applying the token to the infrastructure and processing a payment via the payment processing application for authorization of the transaction; and
communicating approved payment authorization processing to the merchant and the user to allow completion of the transaction.

18. The computer implemented method of claim 17, wherein merchant routing instructions further comprise instructions to route the token to the infrastructure upon being pushed to the merchant system for a transaction, wherein the merchant routing instructions include instructions to route transaction information including a total payment due for the transaction.

19. The computer implemented method of claim 17, wherein the token specific infrastructure comprises components for:
generating tokens with program code for routing the tokens to the infrastructure; and
routing, after the transaction has been initiated, the token to an appropriate payment routing application based on an identification of the account number associated with the payment account.

20. The computer implemented method of claim 17, further comprising performing condition diagnostics on the user device prior to sending the user device the token, wherein performing condition diagnostics comprises determining a security confidence rating for integration of the token to the payment vehicle, wherein the security confidence rating confirms that no malware is present on the user device prior to sending the token.
